(19) United States
(12) Patent Application Publication
(10) Pub. No.: US 2020/0152201 A1
(43) Pub. Date: May 14, 2020

(54) SYSTEM, IMAGE FORMING APPARATUS, METHOD, AND PROGRAM

(71) Applicant: KONICA MINOLTA, INC., Tokyo (JP)

(72) Inventor: Yi-Tsung CHANG, Amagasaki-shi (JP)

(73) Assignee: KONICA MINOLTA, INC., Tokyo (JP)

(21) Appl. No.: 16/668,464

(22) Filed: Oct. 30, 2019

(30) Foreign Application Priority Data
Nov. 13, 2018 (JP) 2018-213043

(51) Int. Cl. G10L 15/30; G06F 3/12; G06F 3/0481; G06F 3/0484; G06F 3/0488

(52) U.S. Cl. CPC G10L 15/30; G06F 3/1278; G06F 3/0488; G06F 3/04842; G06F 3/0481

(57) ABSTRACT

A system includes: an image forming apparatus; a voice processing device that collects voice of an utterance, and generates voice data of the collected voice; and a server, wherein the server includes: a hardware processor that controls the server; and a communication circuit that communicates with the image forming apparatus and the voice processing device, the hardware processor performs a recognition process on the voice data received from the voice processing device, to generate a command for operating the image forming apparatus, and in a case where the image forming apparatus has received the voice data from the voice processing device while executing a job, when the image forming apparatus is in a predetermined state of executing the job, or when the command generated from the voice data is a predetermined command, the hardware processor controls the communication circuit to transmit the generated command to the image forming apparatus.

The entire disclosure of Japanese patent Application No. 2018-213043, filed on Nov. 13, 2018, is incorporated herein by reference in its entirety.

### BACKGROUND

### Technological Field

The present disclosure relates to a system, an image forming apparatus, a method, and a program. More particularly, the present disclosure relates to a system that operates an image forming apparatus in accordance with a command based on voice, the image forming apparatus, a method, and a program.

### Description of the Related art

In recent years, so-called smart speakers have been developed. A smart speaker recognizes voice interactively collected with a microphone, and outputs a command for operating an image forming apparatus to the image forming apparatus in accordance with a result of the recognition. In a case where a smart speaker is placed in the vicinity of an image forming apparatus, when relatively high operating noise generated while the image forming apparatus is executing a print job is collected with a microphone, the smart speaker erroneously recognizes the operating noise as the voice of a command. To avoid erroneous recognition due to operating noise, JP 2005-219460 A discloses a technique for improving the input voice recognition rate by prohibiting voice inputs while the image forming apparatus is in operation, for example.

According to JP 2005-219460 A, all voice inputs are uniformly prohibited while the image forming apparatus is in operation. Therefore, in a case where a command is inadvertently output to the image forming apparatus, a voice input for cancelling the command is also prohibited.

### SUMMARY

In view of this, there is a demand for improvement in the operability of an image forming apparatus depending on voice recognition results.

To achieve the above mentioned object, according to an aspect of the present invention, a system reflecting one aspect of the present invention comprises: an image forming apparatus; a voice processing device that collects voice of an utterance, and generates voice data of the collected voice; and a server, wherein the server includes: a hardware processor that controls the server; and a communication circuit that communicates with the image forming apparatus and the voice processing device, the hardware processor performs a recognition process on the voice data received from the voice processing device, to generate a command for operating the image forming apparatus, and in a case where the image forming apparatus has received the voice data from the voice processing device while executing a job, when the image forming apparatus is in a predetermined state of executing the job, or when the command generated from the voice data is a predetermined command, the hardware processor controls the communication circuit to transmit the generated command to the image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing the configuration of a system according to an embodiment;

FIG. 2 is a diagram schematically showing an example hardware configuration of an MFP according to the embodiment;

FIG. 3 is a diagram schematically showing an example hardware configuration of a server according to the embodiment;

FIG. 4 is a diagram schematically showing an example hardware configuration of a voice processing device according to the embodiment;

FIG. 5 is a diagram schematically showing the structure of job data according to the embodiment;

FIG. 6 is a diagram schematically showing the configuration of a command frame according to the embodiment;

FIG. 7 is a diagram schematically showing an example functional configuration of the server according to the embodiment;

FIG. 8 is a diagram schematically showing an example of a command availability table according to the embodiment;

FIG. 9 is a diagram schematically showing an example of an available command table according to the embodiment;

FIG. 10 is a diagram schematically showing an example functional configuration of the MFP according to the embodiment;

FIG. 11 is a chart schematically showing an example of a process sequence according to the embodiment;

FIG. 12 is a diagram schematically showing an example structure of guidance data according to the embodiment;

FIG. 13 is a diagram schematically showing an example of a state priority table showing priorities with respect to states of the MFP according to the embodiment;

FIG. 14 is a diagram schematically showing an example of a command priority table showing priorities with respect to operation commands for the MFP according to the embodiment;

FIG. 15 is a diagram schematically showing the configuration of a system according to a modification of the embodiment;

FIG. 16 is a diagram schematically showing an example functional configuration of an MFP according to another embodiment; and

FIG. 17 is a flowchart of a process to be performed by the MFP according to another embodiment.

### DETAILED DESCRIPTION OF EMBODIMENTS

Hereinafter, one or more embodiments of the present invention will be described with reference to the drawings. However, the scope of the invention is not limited to the disclosed embodiments. In the description below, like components and constituent elements are denoted by like reference numerals. Like components and constituent elements also have like names and functions. Therefore, explanation of them will not be repeated.

<A. Hardware Configuration>

(a1. System Configuration)

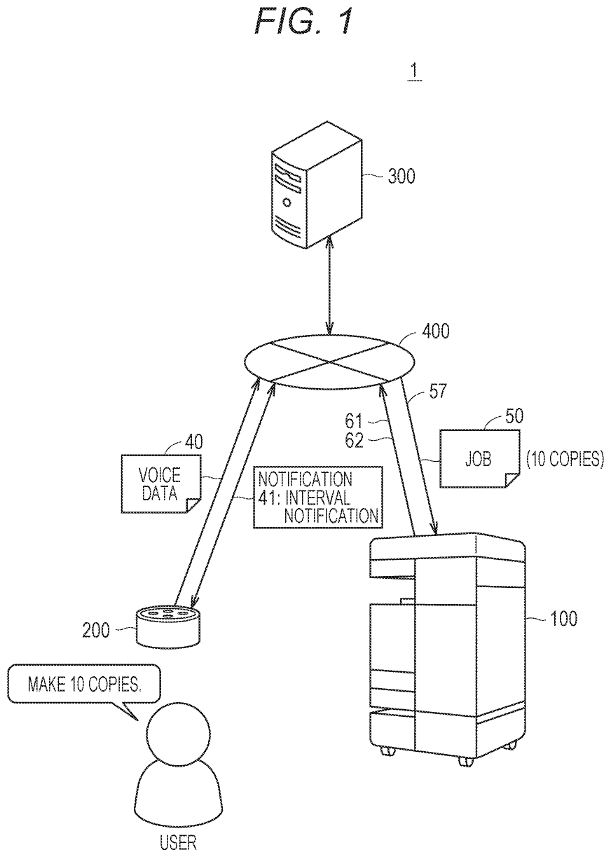

FIG. 1 is a diagram schematically showing the configuration of a system 1 according to an embodiment. As shown in FIG. 1, the system 1 includes multi-function peripherals (MFP) 100 that can be connected to a wired or wireless network 400, a voice processing device 200, and a server 300 that may include a cloud server, for example. The network 400 may include a local area network (LAN) or a global network, or a near field communication network such as Near Field Communication (NFC). The MFP 100 is a printer, a copier, or a complex machine including a printer and a copier, and is an example of an image forming apparatus. Note that the voice processing device 200 or the MFP 100 may be connected to the network 400 via a repeater such as a router.

In the system 1, the user can operate the MFP 100 by speaking. Specifically, when the user utters an operation command such as “make 10 copies.”, for example, the voice processing device 200 collects the voice of the utterance and generates voice data 40 of the collected voice. For example, the voice processing device 200 converts an analog voice signal generated by utterance into digital voice data. The voice processing device 200 transmits the voice data 40 to the server 300 via the network 400. The server 300 performs a voice recognition process on the voice data 40, to convert the voice data 40 into text data as a recognition result. For example, this text data is data of a character code string formed with a character string of one or more characters, and this character string indicates a command for operating the MFP 100.

The server 300 transmits the command represented by the character data to the MFP 100. In FIG. 1, job data 50 or a command frame 57 is transmitted as a command. The MFP 100 processes the job data 50 or the command frame 57. As a result, the MFP 100 is operated in accordance with the command issued by the user. The job data 50 and the command frame 57 will be described later in detail. The MFP 100 also detects its own state, and transmits the detected state 61 to the server 300 on a regular basis. As a result, the server 300 can detect a recent state of the MFP 100 on a regular basis. In this embodiment, states or the MFP 100 include a state that can change during execution of a job. The states are not limited to any particular states, and may include a low-rotation mode in which the motor included in the MFP 100 rotates at low speed, a print job executing state, an operating state in which the user is operating the MFP 100 (that is, the MFP 100 is receiving a user operation via an operation unit 172), and the like, for example.

The MFP 100 also transmits, to the server 300, the time 62 required for a job to be completed in the MFP 100. The MFP 100 may transmit the required time 62 included in the state 61. The server 300 also transmits, to the voice processing device 200, various kinds of notifications including an interval notification 41 for indicating a speech interval to the user.

In the system 1 shown in FIG. 1, the voice processing device 200 is disposed outside the MFP 100, but is not necessarily located outside the MFP 100. For example, the voice processing device 200 may be included in the MFP 100. The system 1 may include a plurality of MFPs 100, and may include a plurality of voice processing devices 200. In this case, the server 300 includes a table in which combinations of the identifiers (addresses) of the respective voice processing devices 200 and the identifiers (addresses) of the respective MFPs 100 nearest to the respective voice processing devices 200 are registered. The server 300 searches the table on the basis of the identifier (address) of the voice processing device 200 included in the voice data 40 from the voice processing device 200, to identify the corresponding MFP 100. The server 300 then transmits the job data 50 and a command 58 to the identified MFP 100.

(a2. Hardware Configuration of the MFP 100)

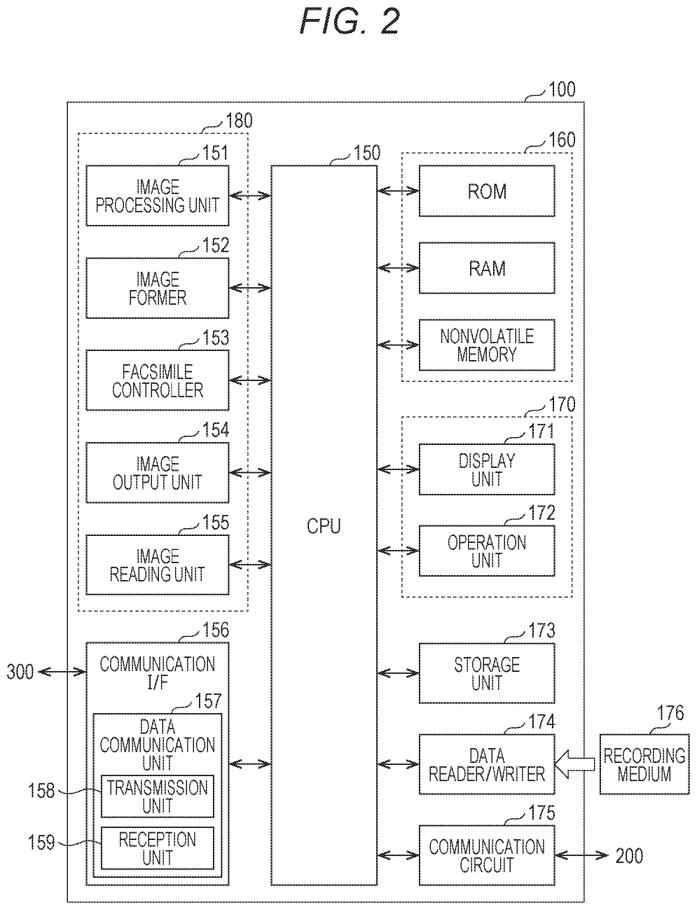

FIG. 2 is a diagram schematically showing an example hardware configuration of the MFP 100 according to the embodiment. As shown in FIG. 2, the MFP 100 includes: a central processing unit (CPU) 150 corresponding to a controller for controlling the MFP 100; a storage unit 160 for storing a program and data; an information input/output unit 170; a communication interface (I/F) 156 for communicating with the server 300 via the network 400; a storage unit 173 such as a hard disk storing various kinds of data including image data; a data reader/writer 174; a communication circuit 175; and an image forming unit 180.

The MFP 100 communicates with external terminals, including the voice processing device 200, via the communication circuit 175.

The storage unit 160 includes a read only memory (ROM) for storing the program to be executed by the CPU 150 and data; a random access memory (RAM) provided as a work area when the CPU 150 executes a program; and a nonvolatile memory.

The input/output unit 170 includes a display unit 171 including a display, and an operation unit 172 that the user operates to input information to the MFP 100. Here, the display unit 171 and the operation unit 172 may be provided as an integrally formed touch panel.

The communication I/F 156 includes circuits such as a network interface card (NIC). The communication I/F 156 also includes a data communication unit 157 for communicating with external devices, including the server 300, via a network. The data communication unit 157 includes a transmission unit 158 for transmitting data to external devices, including the server 300, via the network 400, and a reception unit 159 for receiving data from the external devices, including the server 300, via the network 400.

A recording medium 176 is detachably mounted on the data reader/writer 174. The data reader/writer 174 includes a circuit that reads a program or data from the mounted recording medium 176, and a circuit that writes data into the recording medium 176. The communication circuit 175 includes a communication circuit for a local area network (LAN) or Near Field Communication (NFC), for example.

The image forming unit 180 includes an image processing unit 151, an image former 152, a facsimile controller 153 for controlling a facsimile circuit (not shown), an image output unit 154 for controlling a printer (not shown), and an image reading unit 155.

The image processing unit 151 processes input image data, to perform processing such as enlargement/reduction of an image to be output. The image processing unit 151 is formed with a processor for image processing and a memory, for example. The image former 152 is formed with a toner cartridge, a sheet tray for storing recording paper sheets, hardware resources including a motor for forming images on recording paper sheets, such as a photosensitive member, and hardware resources including a motor for conveying recording paper sheets. The image reading unit 155 is formed with hardware resources designed to generate image data of original documents, such as a scanner for optically reading an original document to obtain image data. The functions of the image processing unit 151, the image former 152, and the image reading unit 155 in the MFP 100 are well known functions, and therefore, detailed explanation thereof is not repeated herein.

The image forming unit 180 receives control data from the CPU 150, generates a drive signal (a voltage signal or a current signal) on the basis of the control data, and outputs the generated drive signal to the respective components (such as the hardware including a motor, for example). As a result, the hardware of the image forming unit 180 operates in accordance with a command. For example, the image output unit 154 drives the printer in accordance with a command. The command for driving the printer is generated by the CPU 150 processing the print job data 50, for example.

(a3. Hardware Configuration of the Server 300)

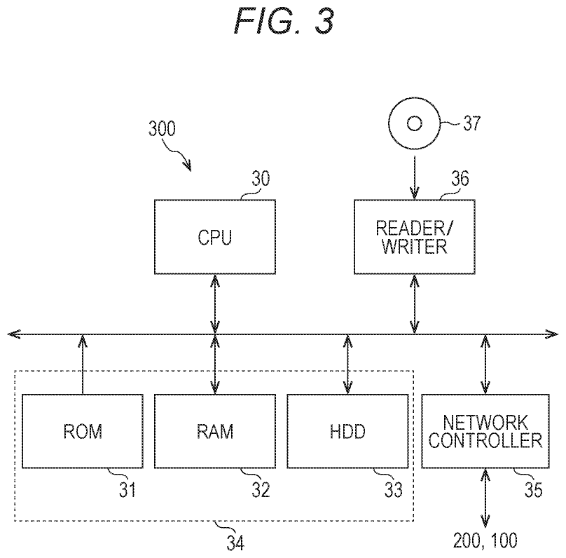

FIG. 3 is a diagram schematically showing an example hardware configuration of the server 300 according to the embodiment. As shown in FIG. 3, the server 300 includes a CPU 30 for controlling the server 300, a storage unit 34, a network controller 35, and a reader/writer 36. The storage unit 34 includes a ROM 31 for storing the program to be executed by the CPU 30 and data, a RAM 32, a hard disk drive (HDD) 33 for storing various kinds of information, and the network controller 35 that communicates with the MFP 100 and the voice processing device 200. The RAM 32 includes an area for storing various kinds of information, and a work area for the CPU 30 to execute the program. The network controller 35 is an example of a communication circuit for communicating with the MFP 100 and the voice processing device 200. The network controller 35 includes an NIC and the like.

A recording medium 37 is detachably mounted on the reader/writer 36. The reader/writer 36 includes a circuit for reading a program or data from the mounted recording medium 37, and a circuit for writing data into the recording medium 37.

(a4. Hardware Configuration of the Voice Processing Device 200)

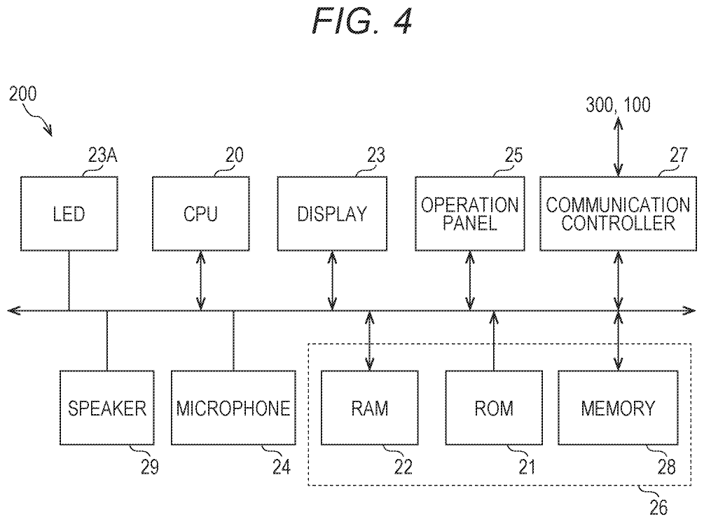

FIG. 4 is a diagram schematically showing an example hardware configuration of the voice processing device 200 according to the embodiment. As shown in FIG. 4, the voice processing device 200 includes a CPU 20 corresponding to the controller for controlling the voice processing device 200, a display 23, a light emitting diode (LED) 23A, a microphone 24, an operation panel 25 that the user operates to input information to the voice processing device 200, a storage unit 26, a communication controller 27 including a communication circuit such as an NIC or a LAN circuit, and a speaker 29. The storage unit 26 includes a ROM 21 for storing the program to be executed by the CPU 20 and data, a RAM 22, and a memory 28 including a hard disk device. The display 23 and the operation panel 25 may be provided as an integrally formed touch panel. The voice processing device 200 can communicate with the server 300 or the MFP 100 or the like via the communication controller 27.

The voice processing device 200 collects sound including utterances via the microphone 24. The CPU 20 converts a voice signal of the collected sound into digital data, to generate the voice data 40. The voice processing device 200 also reproduces voice data. Specifically, the CPU 20 converts voice data into a voice signal, and outputs the converted voice signal to the speaker 29. As a result, the speaker 29 is driven by the voice signal, and voice is output from the speaker 29. Voice data to be output from the speaker 29 includes voice data stored in the storage unit 26 or voice data received from an external device such as the server 300 or the MFP 100, for example.

<B. Job Data 50 and Command Frame 57>

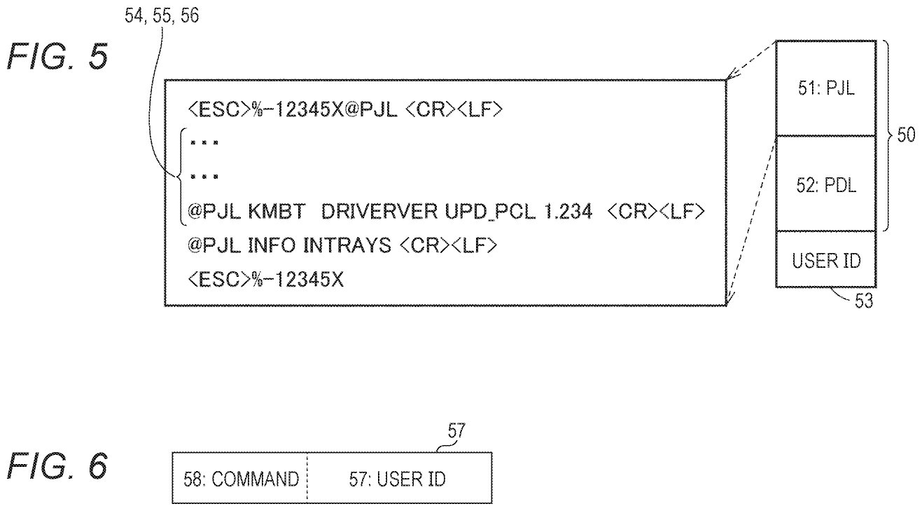

FIG. 5 is a diagram schematically showing the structure of the job data 50 according to the embodiment. The job data 50 in FIG. 5 corresponds to a job for causing the printer of the image output unit 154 to print an image, for example. As shown in FIG. 5, the job data 50 includes PJL data 51, page description language (PDL) data 52, and the identifier of the job data 50, such as a user ID 53 for identifying the user of the job data 50, for example. In this embodiment, the server 300 converts the data to be printed (hereinafter referred to as the print target data) into the PDL data 52, and the PDL data 52 accompanied by the PJL data 51 and the user ID 53 is transmitted as the job data 50 to the MFP 100. The PJL data 51 indicates a command written in the PJL format. This command may include a command that is generated by the server 300 performing a recognition process on the voice data 40 received from the voice processing device 200 and is designed for operating the MFP 100.

The user ID 53 is the identifier of the user of the job data 50, and includes the login name of the user of the voice processing device 200 or the MFP 100, for example. The CPU 30 of the server 300 can receive the login name of the user from the voice processing device 200 or the MFP 100.

As shown in FIG. 5, the PJL data 51 defines various kinds of instructions that do not directly affect the PDL data 52. For example, a print command (a command relating to setting of the number of copies to be printed) 54, commands 55 and 56 relating to execution of a function of the MFP 100, such as stapling or punching (not shown), and the like are written in the PJL data 51.

The print target data is not limited to any particular kind, and may be document data, figure data, or table data, for example. The storage unit 34 of the server 300 can store the print target data associated with a user identifier (such as a login name) for each user. For example, the CPU 30 of the server 300 converts the print target data in the storage unit 34 associated with the received user identifier (login name) into the PDL data 52.

The print target data is stored in the server 300 in this embodiment, but is not necessarily stored in the server 300. In a modification, the print target data may be stored in the storage unit 173 of the MFP 100. In this case, the PDL data 52 of the job data 50 indicates the print target data stored in the storage unit 173. Specifically, after receiving the PJL data 51 and the user ID 53 from the server 300, the CPU 150 converts the print target data in the storage unit 173 associated with the user ID 53 into the PDL data 52. Thus, the CPU 150 of the MFP 100 can generate the job data 50 from the PDL data 52 generated from the PJL data 51 and the user ID 53 received from the server 300 and the print target data in the storage unit 173.

The job data 50 is processed by the MFP 100. Specifically, the image output unit 154 expands the PDL data 52 of the job data 50 as bitmap data in the RAM of the storage unit 160, using firmware (not shown). The printer (not shown) of the image output unit 154 performs a printing process on printing paper in accordance with the bitmap data (the PDL data 52), and executes a stapling function, a sorter function for printing a designated number of copies, and the like by executing a command of the PJL data 51.

In this embodiment, the job data 50 is not limited to the print job described above, and may be a facsimile communication job, for example.

FIG. 6 is a diagram schematically showing the configuration of the command frame 57 according to the embodiment. Unlike the job data 50, the command frame 57 in FIG. 6 has a format that does not include the data to be processed (such as the PDL data 52, for example). The command frame 57 includes a command 58 and the user ID 53. The command 58 is a command that is generated by the server 300 performing a recognition process on the voice data 40 received from the voice processing device 200 and is designed for operating the MFP 100.

<C. Functional Configuration of the Server 300>

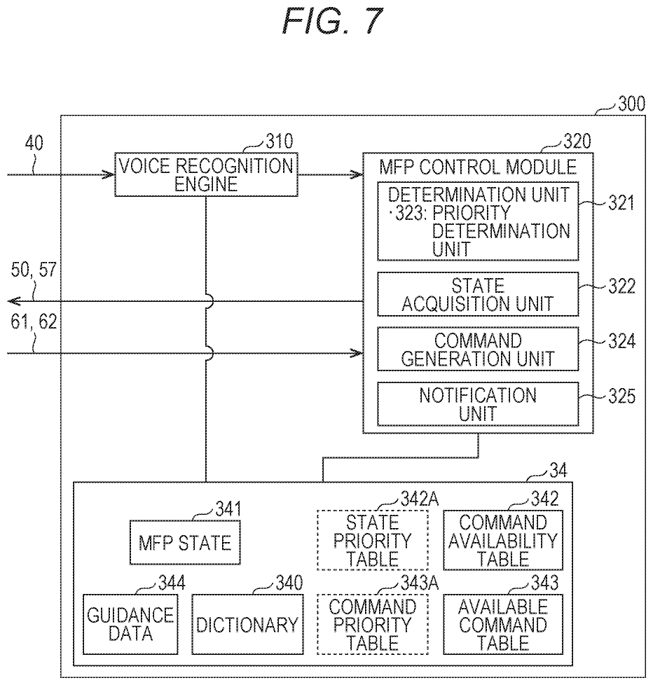

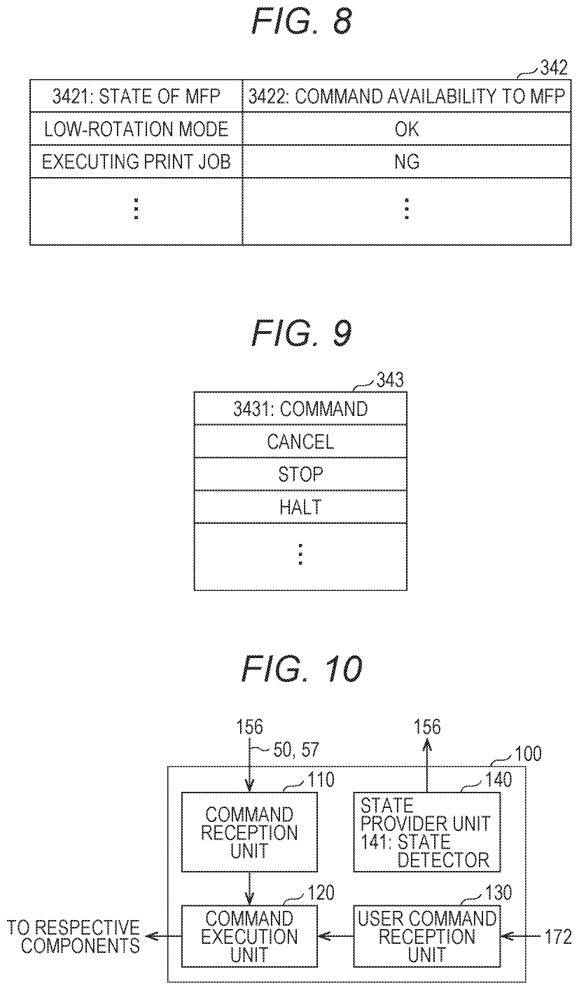

FIG. 7 is a diagram schematically showing an example functional configuration of the server 300 according to the embodiment. FIG. 8 is a diagram schematically showing an example of a command availability table 342 according to the embodiment. FIG. 9 is a diagram schematically showing an example of an available command table 343 according to the embodiment. As shown in FIG. 7, the server 300 includes a voice recognition engine 310 that performs a voice recognition process using the voice data 40 received via the network controller 35, and an MFP control module 320 that generates the job data 50 or the command frame 57 on the basis of a voice recognition result. The server 300 transmits the generated job data 50 and the command frame 57 to the MFP 100 via the network controller 35.

The voice recognition engine 310 or the MFP control module 320 is formed by the CPU 30 executing a program stored in the storage unit 34 or the recording medium 37. Note that the voice recognition engine 310 or the MFP control module 320 may be formed with a circuit such as an application specific integrated circuit (ASIC) or a field-programmable gate array (FPGA), or a combination of a circuit and a program.

The storage unit 34 also stores a dictionary 340, an MFP state 341 indicating a state of the MFP 100, the command availability table 342 (see FIG. 8), the available command table 343 (see FIG. 9), guidance data 344, a state priority table 342A (see FIG. 13), and a command priority table 343A (see FIG. 14). The dictionary 340 registers a plurality of commands for operating the MFP 100, and text data corresponding to the respective commands (text data formed with character strings representing the commands).

The MFP control module 320 includes a determination unit 321, a state acquisition unit 322, a command generation unit 324, and a notification unit 325. The determination unit 321 determines whether to transmit the command 58 (that is, the command frame 57), in accordance with the MFP state 341, the command availability table 342, and the available command table 343 in the storage unit 34. A priority determination unit 323 included in the determination unit 321 determines whether to transmit time command 58 (that is, the command frame 57), in accordance with the MFP state 341, the state priority table 342A, and the command priority table 343A in the storage unit 34. The priority determination unit 323 will be described later in detail.

The state acquisition unit 322 receives the state 61 of the MFP 100 from the MFP 100, and stores the received state 61 as the MFP state 341 into the storage unit 34. In this embodiment, the MFP 100 detects its state 61 on a regular basis, and transmits the state 61 to the server 300. Alternatively, when there is a change in the state of the MFP 100, the MFP 100 transmits the state 61 to the server 300. Thus, the MFP state 341 constantly indicates the latest state of the MFP 100.

The method by which the state acquisition unit 322 acquires the state 61 is not limited to the above. For example, the state acquisition unit 322 may transmit an inquiry to the MFP 100 on a regular basis, and, in response to the inquiry, the MFP 100 may transmit the state 61 to the server 300. Alternatively, the MFP state 341 may include a time-series state 61 in compliance with the sequence in which states 61 are received.

As shown in FIG. 8, the command availability table 342 includes a plurality of states 3421 in which the MFP 100 can be, and command availability data 3422 associated with the respective states 3421. The command availability data 3422 indicates whether to permit command transmission to the MFP 100 (permitted: OK), or whether to prohibit transmission (prohibited: NG). In the command availability table 342, the states 3421 of the MFP 100 include “low-rotation mode” in which the printer motor rotation speed is low and the operating noise is relatively low, and “print job executing mode” in which the operating noise is relatively high, for example, though not necessarily. The command availability data 3422 corresponding to the state 3421 in the “low-rotation mode” indicates “OK”, and the command availability data 3422 corresponding to the state 3421 in the “print job executing mode” indicates “NG”.

The command availability table 342 specifies that transmission of the command 58 (the command frame 57) from the server 300 to the MFP 100 is not permitted when the operating noise being generated from the hardware (a motor, a sorter, or the like) of the MFP 100 is low, and that transmission of the command 58 (the command frame 57) is permitted when the operating noise being generated from the MFP 100 is low.

Therefore, according to the command availability table 342, the command 58 based on a result of recognition of the voice data 40 is not transmitted to the MFP 100 when the MFP 100 is generating high operating noise. As a result, when there is a possibility that operating noise will be mixed into the voice in a user's utterance, and the voice data 40 may be erroneously recognized, transmission of the command 58 of the voice data 40 to the MFP 100 is not permitted. Thus, the MFP 100 can be prevented from being erroneously operated in accordance with a command based on the erroneous recognition.

As shown in FIG. 9, the available command table 343 is a table linked to the values of “NG” in the command availability data 3422 in the command availability table 342, and contains commands 3431 corresponding to one or more operations allowed to perform transmission to the MFP 100. The commands 3431 are for urgently operating the MFP 100, and may include commands for urgently stopping or suspending a job being executed, for example. Each command 3431 is indicated by text data formed with the character string representing the command. The contents of the available command table 343 in FIG. 9 may be the same or different for the respective states 3421 in which the command availability data 3122 shows “NG”.

The voice recognition engine 310 converts text data indicating a recognition result into a command for operating the MFP 100 (such a command will be hereinafter also referred to as a recognition command). For this conversion, the dictionary 340 is used, for example. The dictionary 340 registers a plurality of commands for operating the MFP 100, and text data corresponding to the respective commands (text data formed with character strings representing the commands). Accordingly, the voice recognition engine 310 can realize the conversion by searching the dictionary 340 on the basis of the text data of the recognition result.

The determination unit 321 of the MFP control module 320 determines whether to transmit the recognition command to the MFP 100. Specifically, the determination unit 321 searches the command availability table 342 on the basis of the MFP state 341, to retrieve the command availability data 3422 corresponding to the state 3121 matching the MFP state 341 from the command availability table 342. When the retrieved command availability data 3122 indicates “NG”, which is when the recognition command (the command 58) is determined not to be transmitted on the basis of the state 311 of the MFP 100, the determination unit 321 performs the next process on the recognition command.

In the next process, the determination unit 321 searches the available command table 343 in accordance with the recognition command, to determine whether the recognition command is a command 3431 registered in the available command table 343. When the determination unit 321 determines that the recognition command is a command 3431 registered in the available command table 343, the determination unit 321 determines to transmit the recognition command to the MFP 100.

The command generation unit 324 generates the command frame 57 that includes the recognition command determined to be transmitted by the determination unit 321 as the command 58. The MFP control module 320 controls the network controller 35, to transmit the generated command frame 57 to the MFP 100. When the determination unit 321 determines that the recognition command is not registered in the available command table 343, on the other hand, the determination unit 321 finally determines not to transmit the recognition command to the MFP 100.

When the recognition command (the command 58 of the command frame 57) is executed by the MFP 100, or when the execution is completed, the notification unit 325 generates voice data indicating that “the command has been executed (or the execution has been completed)”, and transmits the voice data to the MFP 100. When the command 58 is transmitted to the MFP 100 by the network controller 35, the notification unit 325 may transmit a notification that the execution has been completed to the MFP 100.

When the determination unit 321 determines that transmission of the recognition command is prohibited, the notification unit 325 generates voice data of a notification that “the command has not been executed”, and transmits the voice data to the voice processing device 200. In this case, from a combination of the MFP state 341 and the recognition command (such as a paper size change), the notification unit 325 may generate voice data for guidance relating to operation of the MFP 100, such as “Paper size can be changed when job execution ends”. The guidance data 344 stores a plurality of sets of commands and states, and voice data for guidance associated with the respective sets. By searching the guidance data 344 on the basis of the MFP state 341 and the recognition command, the notification unit 325 can acquire the voice data of the guidance corresponding to the MFP state 341 and the recognition command.

The notification unit 325 transmits a notification to the voice processing device 200, and the voice processing device 200 outputs a notification from the server 300 through the speaker 29, the LED 23A, the display 23, or the like. However, the output forms are not limited to the above. For example, the notification unit 325 transmits the notification to the user's portable terminal. In this case, the portable terminal transmits the notification from the server 300 by voice, an image, or lighting.

<D. Functional Configuration of the MFP 100>

FIG. 10 is a diagram schematically showing an example functional configuration of the MFP 100 according to the embodiment. As shown in FIG. 10, the MFP 100 includes a command reception unit 110, a command execution unit 120, a user command reception unit 130, and a state provider unit 140. The command reception unit 110 receives the job data 50 or the command frame 57 transmitted from the server 300 via the communication I/F 156. The user command reception unit 130 receives a command that is input to the MFP 100 by the user operating the operation unit 172. The command execution unit 120 interprets a command received by the command reception unit 110 or the user command reception unit 130, generates control data, and outputs the generated control data to the respective components.

The respective components of the MFP 100 are driven in accordance with the control data, and as a result, the MFP 100 is operated in accordance with the command (the PJL data 51) of the job data 50 or the command 58 of the command frame 57.

The state provider unit 140 includes a state detector 141 that periodically detects the state 61 of the MFP 100. The state detector 141 detects the state 61 of the MFP 100, on the basis of a signal or data that is output from each component of the MFP 100 or on the basis of mode data that is stored in the storage unit 160 and indicates the operation mode of the MFP 100. The state provider unit 140 periodically transmits the detected state 61 to the server 300. The state provider unit 140 also transmits the state 61 to the server 300 when the state 61 of the MFP 100 changes. Thus, the state provider unit 140 can transmit the recent state 61 of the MFP 100 to the server 300.

Each of the components shown in FIG. 10 is formed by the CPU 150 executing a program stored in the storage unit 160 or the recording medium 176. Alternatively, each of the components in FIG. 10 may be formed with a circuit such as an ASIC or an FPGA, or a combination of a circuit and a program.

<E. Sequence>

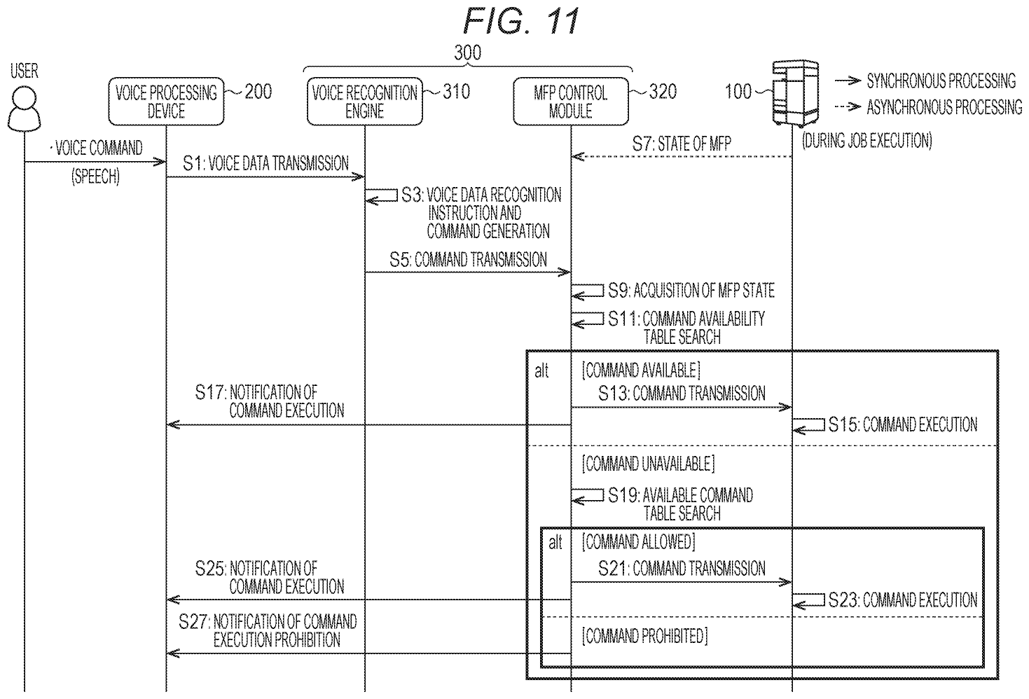

FIG. 11 is a chart schematically showing an example of a process sequence according to the embodiment. In the sequence shown in FIG. 11, a process to be performed by the voice processing device 200, processes to be performed by the voice recognition engine 310 and the MFP control module 320 of the server 300, and a process to be performed by the MFP 100 executing a job are associated with one another.

As shown in FIG. 11, in the MFP 100 that is executing a job, the state provider unit 140 transmits a state 61 to the server 300. Each time the state acquisition unit 322 of the server 300 receives a state 61 from the MFP 100, the state acquisition unit 322 updates the MFP state 341 using the received state 61 (step S7). Since the state 61 includes a state indicating that the MFP 100 is executing a job, the server 300 detects, from the MFP state 341, that the MFP 100 is executing a job.

The user issues an utterance for operating the MFP 100. The voice processing device 200 collects the voice of the utterance, and transmits the voice data 40 to the server 300 (step S1). The voice recognition engine 310 of the server 300 performs a recognition process on the received voice data 40, generates a recognition command from the recognition result (text data) (step S3), and transmits the generated recognition command to the MFP control module 320.

The determination unit 321 of the MFP control module 320 acquires the MFP state 341 by reading the MFP state 341 from the storage unit 34 (step S9). The determination unit 321 also searches the command availability table 342 on the basis of the MFP state 341, to retrieve the value of the command availability data 3422 corresponding to the state 3421 matching the MFP state 341 (step S11).

If the determination unit 321 determines that the value of the corresponding command availability data 3422 indicates “OK”, or the MFP 100 is in a state in which command transmission is permitted, the command generation unit 324 generates a command frame 57 including a recognition command as a command 58. The MFP control module 320 transmits the command frame 57 to the MFP 100 (step S13). In the MFP 100, the command reception unit 110 receives the command frame 57, and the command execution unit 120 executes the command 58 of the received command frame 57 (step S15).

On the other hand, if the determination unit 321 determines that the value of the corresponding command availability data 3422 indicates “NG”, or the MFP 100 is in a state in which command transmission is not permitted, the determination unit 321 searches the available command table 343.

Specifically, the determination unit 321 searches the available command table 343 in accordance with the recognition command, to determine whether the recognition command is a command 3431 registered in the available command table 343 (step S19). If the determination unit 321 determines that the recognition command is registered in the available command table 343, the determination unit 321 finally determines that the recognition command can be transmitted to the MFP 100. The command generation unit 324 generates a command frame 57 including a command 58 that is the recognition command determined to be transmittable, and the MFP control module 320 transmits the generated command frame 57 to the MFP 100 (step S21). The command execution unit 120 of the MFP 100 executes the command 58 in the command frame 57 from the server 300 (step S23).

On the other hand, if the determination unit 321 determines that the recognition command is not registered in the available command table 343, the determination unit 321 finally determines that transmission of the recognition command to the MFP 100 is prohibited, and performs processing so that the recognition command is not to be transmitted to the MFP 100 (step S26). This processing includes discarding of the recognition command or storing of the recognition command into a predetermined area of the storage unit 34.

In step S15 or S23 described above, when the command execution unit 120 of the MFP 100 executes a command 58 issued in the form of an utterance, the command execution unit 120 transmits a notification that the execution has been completed to the server 300 (step S16 or S24). When the MFP control module 320 receives the notification that the command has been executed from the MFP 100, the MFP control module 320 transmits voice data notification that “the command has been executed” to the voice processing device 200 (step S17 or S25). In step S26 described above, the MFP control module 320 transmits a voice data notification that “the command has not been executed” to the voice processing device 200 (step S27).

The voice processing device 200 reproduces the voice data received in step S17, step S25, or step S27 (step S29). As a result, a voice that guides whether the command has been executed by the MFP 100 is output from the speaker 29 of the voice processing device 200. Thus, in a case where the user issues a command to operate the MFP 100 through an utterance, the user can check whether the command has been executed by the MFP 100 through an interactive communication with the voice processing device 200.

(e1. Switching of Operation Modes of the MFP 100)

If it is determined in step S26 in FIG. 11 that command execution is prohibited, the server 300 may transmit, to the MFP 100, a command frame 57 including a command 58 for switching the operation mode to a silent mode with less operating noise. As the command execution unit 120 of the MFP 100 executes the command 58, the operation mode of the MFP 100 switches to the silent mode, and the MFP state 341 indicates the silent mode. The silent mode corresponds to the state 3421 indicating the low-rotation mode in the command availability table 342, for example. Accordingly, after the operation mode switches to the silent mode, the command 58 based on the user's utterance can be transmitted to the MFP 100 via the server 300.

(e2. Modification of Notification)

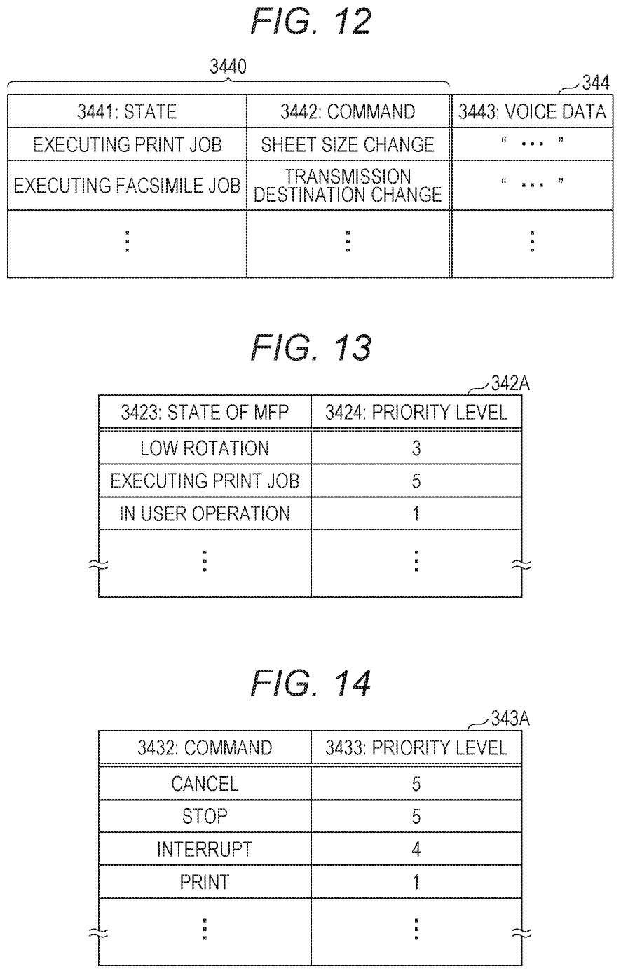

FIG. 12 is a diagram schematically showing an example structure of the guidance data 344 according to the embodiment. As shown in FIG. 12, the guidance data 344 stores a plurality of sets 3440, and guidance voice data 3443 relating to operation of MFP 100 in association with the respective sets 3440.

For example, the notification unit 325 searches the guidance data 344 on the basis of the set of the MFP state 341 acquired in step S9 and the recognition command received in step S5. The notification unit 325 retrieves from the guidance data 344 the voice data 3443 corresponding to the set 3440 that matches the set. The guidance data 344 may include guidance regarding operation of the MFP 100. For example, in a case where the MFP state 341 indicates “a print job is being executed”, and the recognition command issued in the form of an utterance indicates “paper size change”, the notification unit 325 searches the guidance data 344 so that the guidance voice data 3443 such as “paper size can be changed when print job execution is completed” can be acquired (generated). The notification unit 325 transmits a notification including the acquired guidance voice data 3443 to the voice processing device 200.

The voice processing device 200 reproduces the guidance voice data 3443 included in the notification. Thus, guidance regarding operation of the MFP 100 for executing a command can be provided to the user in an interactive manner.

(e3. Another Modification of Notification)

The notification that the command has not been executed in step S27 in FIG. 11 may include information about the time required for executing a job, which is the time 62 required until the job is completed.

In this embodiment, the MFP 100 estimates the time 62 required for executing a print job. For example, the MFP 100 calculates the total number of paper sheets from the number of jobs waiting for printing at the time of reception of a job start operation command and the number of copies in each of the jobs, and estimates the required time 62 that is the value obtained by performing correction such as adding an inter-job interval to the value obtained by dividing the total number of paper sheets by the print speed of the MFP 100. The MFP 100 transmits a notification of the required time 62 to the server 300. Alternatively, the MFP 100 may transmit the required time 62 together with a state 61 to the server 300.

The above estimation (calculation) of the required time 62 may be performed by the MFP control module 320. In that case, the MFP 100 transmits the number of jobs waiting for printing and the number of copies in each of the jobs, together with the state 61, to the server 300.

In this manner, the voice processing device 200 can reproduce the voice data of the required time 62, as well as the voice data of the notification that the command has not been executed.

(e4. Yet Another Modification of Notification)

In this embodiment, the above notification may include a notification indicating the timing for inputting a command to the MFP 100.

Specifically, jobs to be executed by the MFP 100 include a job for changing the state of the MFP 100 to a state in which operating noise is periodically output. For example, when the MFP 100 is executing a print job, a stapling command is executed, so that the state 61 of the MFP 100 (which is the MFP state 341) changes as follows: “stapling start→stapling stop→stapling start→stapling stop→stapling start→”. Thus, operating noise is output from the MFP 100 in synchronization with stapling start cycles.

The MFP control module 320 measures the intervals at which operating noise is output on the basis of the state 61 received from the MFP 100. In other words, the MFP control module 320 measures the interval between a stapling start and the next stapling start. The notification unit 325 controls the network controller 35 to transmit a predetermined notification to the voice processing device 200 periodically in synchronization with the measured interval. The predetermined notification includes an interval notification 41 that is a notification indicating the utterance interval to the user, for example.

The voice processing device 200 controls the speaker 29 to output a predetermined sound at each interval indicated by a predetermined notification (the interval notification 41), or turns on the LED 23A. As a result, even when the MFP 100 is executing a print job using the stapling function, the user can be guided to a time when operating noise is low, or to an appropriate time for speaking (a time when the voice of an utterance can be appropriately collected).

(e5. Further Modification of Notification)

Notifications to be transmitted from the server 300 to the voice processing device 200 may include an inquiry regarding a recognition command in the form of an utterance. For example, when the voice recognition engine 310 searches the dictionary 340 on the basis of text data obtained by recognizing the voice data 40, and determines that the text data is not registered in the dictionary 340 on the basis of the search result, the notification unit 325 generates an inquiry notification and transmits the inquiry notification to the voice processing device 200. The voice processing device 200 outputs the inquiry received from the server by voice from the speaker 29 or lighting of the LED 23A.

Specifically, in a case where utterances are issued at stapling start intervals as described above, the voice processing device 200 transmits, to the server 300, a plurality of pieces of voice data 40 in the form of short utterances issued at the stapling start intervals. The voice recognition engine 310 recognizes the plurality of pieces of voice data 40, and generates a plurality of pieces of text data. The voice recognition engine 310 integrates the plurality of pieces of text data, and searches the dictionary 340 on the basis of the integrated text data. If the voice recognition engine 310 determines that the text data is not registered in the dictionary 340 as a result of the search, the notification unit 325 generates voice data as an inquiry regarding the command, and transmits a notification including the voice data to the voice processing device 200.

The voice processing device 200 reproduces the inquiry voice data included in the notification received from the server 300 with the speaker 29, or notifies that the inquiry has been received by turning on the LED 23A. This can prompt the user to issue an utterance for operating the MFP 100.

In this case, the voice recognition engine 310 may add text data candidates to the above inquiry. Specifically, the voice recognition engine 310 calculates the similarity between text data obtained through a voice recognition process and each piece of text data in the dictionary 340, and extracts the text data having high degrees of similarity from the dictionary 340. The inquiry voice data may be voice data generated from the text data having high degrees of similarity. Thus, it is possible to guide the user to candidate operations (or commands) when prompting the user to issue an utterance for operating the MFP 100.

<F. Processes to be Performed by the Priority Determination Unit 323>

FIG. 13 is a diagram schematically showing an example of the state priority table 342A showing priorities with respect to states of the MFP according to the embodiment. FIG. 14 is a diagram schematically showing an example of the command priority table 343A showing priorities with respect to operation commands for the MFP according to the embodiment. Referring now to FIGS. 13 and 14, processes to be performed by the priority determination unit 323 are described.

(f1. Process Depending on State Priorities)

In a modification of the embodiment, the state priority table 342A in FIG. 13 may be used in place of the command availability table 342 in FIG. 8. According to the command availability table 342, when the MFP 100 is in a state 3421 in which the operating noise is low, the server 300 is permitted to transmit a command 58 based on the user's utterance to the MFP 100. In the state priority table 342A, on the other hand, states 3423 that the MFP 100 can be in during job execution, and priorities 3424 associated with the respective states 3423 are set.

In this modification, the MFP 100 receives a command directed thereto. Each state 3423 that can change during job execution is associated with a priority 3424 indicating that a command received by the MFP 100 that is executing a job should be preferentially processed over other commands.

As shown in the state priority table 342A, each state 3423 that the MFP 100 can be in during job execution is associated with a priority 3424 indicating the degree at which a command 58 from the server 300 should be preferentially processed over other commands. Further, the greater the value indicated by a priority 3424, the higher the degree at which the command should be preferentially processed.

When the MFP control module 320 receives a recognition command based on voice data 40, the priority determination unit 323 searches the state priority table 342A on the basis of the MFP state 341. From the result of the search, the priority determination unit 323 determines whether the MFP state 341 matches any of the states 3423 associated with the priorities 3424 equal to or higher than a predetermined value in the state priority table 342A. When the priority determination unit 323 determines that the MFP state 341 matches at least one of the states 3423, the command generation unit 324 transmits a command frame 57 including the recognition command as the command 58 to the MFP 100.

(f2. Process Depending on Command Priorities)

In a modification of the embodiment, the command priority table 343A in FIG. 14 may be used in place of the available command table 343 in FIG. 9. The command priority table 343A shows a plurality of commands 3432 that can be recognized on the basis of voice data 40, and priorities 3433 associated with the respective commands 3432. In the embodiment, commands based on voice data 40 include commands for urgently operating the MFP 100. The degrees of urgency of operations indicated by the respective commands registered in the available command table 343 or the command priority table 343A are higher than the degrees of urgency of other operations to be performed on the MFP 100.

In the command priority table 343A, the priorities 3433 indicate the degrees (priorities) at which the corresponding commands 3432 should be preferentially executed over other operation commands to be issued to the MFP 100. In the command priority table 343A, the higher the value indicated by a priority 3433, the higher the degree of priority, for example. In other words, the degree of urgency of the corresponding command for urgently operating the MFP 100 is high.

When the MFP control module 320 receives a recognition command based on voice data 40, the priority determination unit 323 searches the command priority table 343A on the basis of the received recognition command. From the result of the search, the priority determination unit 323 determines whether the recognition command matches any of the commands 3432 associated with the priorities 3433 equal to or higher than a predetermined value in the command priority table 343A. When the priority determination unit 323 determines that the recognition command matches at least one of the commands 3432, the command generation unit 324 transmits a command frame 57 including the recognition command as the command 58 to the MFP 100.

(f3. Combination of Priorities)

The priority determination unit 323 may perform determination on the basis of a combination of the state priority table 342A and the command priority table 343A.

For example, in a case where the priority determination unit 323 determines that an MFP state 341 is not in a predetermined state (which is a state with a priority equal to or higher than a predetermined value) on the basis of a result of search of the state priority table 342A, the priority determination unit 323 further searches the command priority table 343A on the basis of a recognition command. When the priority determination unit 323 determines, from a result of the search, that the priority 3433 corresponding to the command 3432 matching the recognition command indicates a value equal to or higher than a predetermined value, the command generation unit 324 outputs a command frame 57 including the recognition command as the command 58 to the MFP 100. Accordingly, when a recognition command is an urgent operation command (such as cancellation of a job or stopping of a job), for example, the recognized command 58 is transmitted to the MFP 100 regardless of the state of the MFP 100, so that the MFP 100 can be urgently operated.

<G. Modification of the System 1>

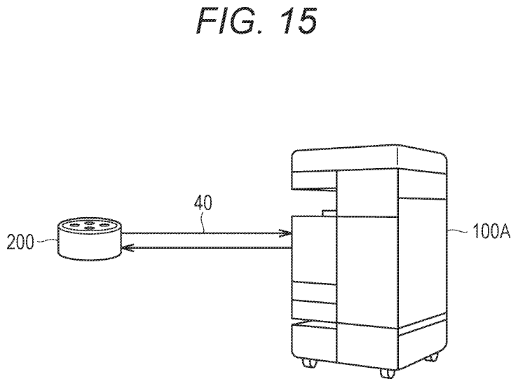

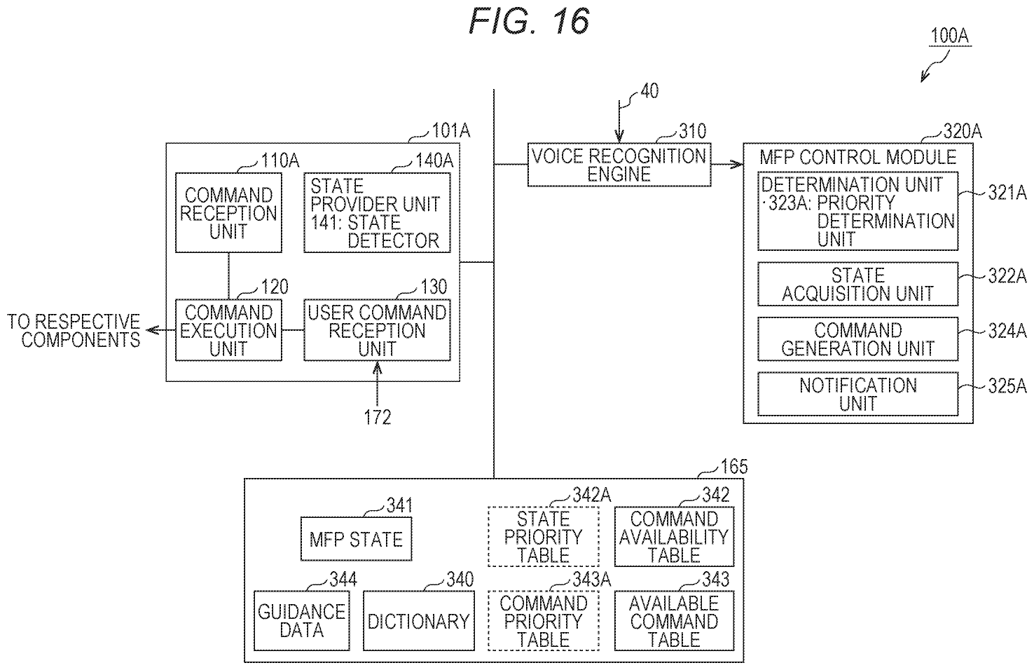

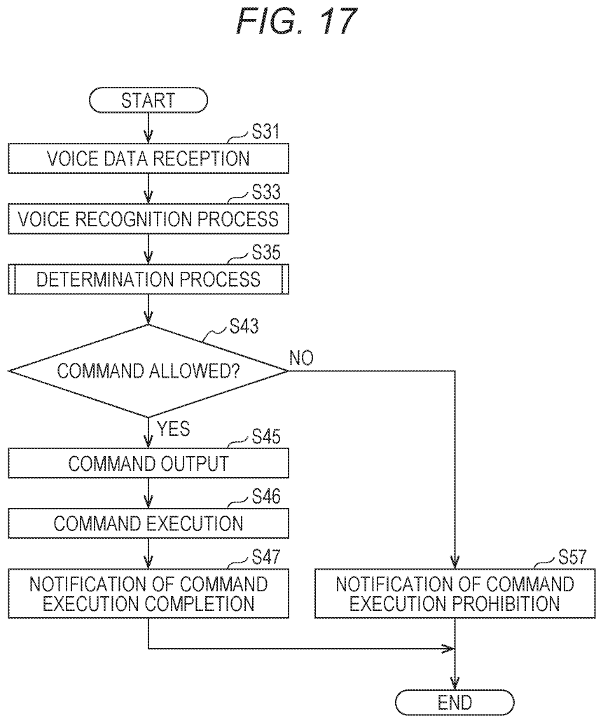

In a system 1A according to a modification of the system 1, the MFP includes a voice recognition engine and an MFP control module. FIG. 15 is a diagram schematically showing the configuration of the system 1A according to the modification of the embodiment. FIG. 16 is a diagram schematically showing an example functional configuration of an MFP 100A according to another embodiment. FIG. 17 is a flowchart of a process to be perforated by the MFP 100A according to another embodiment.

As shown in FIG. 15, the system 1A includes a voice processing device 200, and the MFP 100A that performs wireless communication with the voice processing device 200 via a LAN or the like. As shown in FIG. 16, the MFP 100A includes a voice recognition engine 310 and an MFP control module 320A that perform a voice recognition process on voice data 40 from the voice processing device 200, a peripheral function module 101A that provides peripheral functions, and a storage unit 165. Each component included in the MFP 100A in FIG. 16 is an example of an “information processor”. Each component included in the MFP 100A in FIG. 16 is formed by a CPU 150 executing a program stored in a storage unit 160 or a recording medium 176. Alternatively, each of the components in the MFP 100A in FIG. 16 may be formed with a circuit such as an ASIC or an FPGA, or a combination of a circuit and a program.

The storage unit 165 includes a storage area for the storage unit 160 or the recording medium 176. The storage unit 165 stores the same information as that stored in the storage unit 34 shown in FIG. 7, and therefore, explanation thereof is not repeated herein.

The peripheral function module 101A has the same configuration as the functional configuration shown in FIG. 10. Specifically, the peripheral function module 101A includes a command reception unit 110A that receives a command (PJL data 51) of job data 50 or a command 58 from the MFP control module 320A, a command execution unit 120, a user command reception unit 130, and a state provider unit 140A. The command reception unit 110A receives job data 50 or a command 58 from the MFP control module 320A. The command execution unit 120 and the user command reception unit 130 have the same functions as those in FIG. 10, and therefore, explanation thereof is not repeated herein.

The state provider unit 140A includes a state detector 141 that detects the state of the MFP 100A periodically or when there is a change in the state. The state provider unit 140A stores the state detected by the state detector 141 as an MFP state 341 into the storage unit 165.

The MFP control module 320A includes: a determination unit 321A for determining whether to transmit a command 58 to the peripheral function module 101A in accordance with the MFP state 341, the command availability table 342, and the available command table 343 in the storage unit 165; a state acquisition unit 322A that acquires a state by reading the MFP state 341 in the storage unit 165; a command generation unit 324A that generates the command 58 (a command frame 57) and transmits the command 58 to the peripheral function module 101A; and a notification unit 325A that transmits a notification to the voice processing device 200. The determination unit 321A includes a priority determination unit 323A. The respective components included in the MFP control module 320A have the same functions as those described above with reference to FIG. 7, and therefore, explanation of them is not repeated herein.

Referring now to FIG. 17, a process to be performed by the MFP 100A is described. Note that the MFP 100A is executing a job. First, when the MFP 100A receives voice data 40 from the voice processing device 200 (step S31), the voice recognition engine 310 performs a voice recognition process on the voice data 40, and outputs a recognition command based on the result of the recognition (step S33).

In MFP control module 320A, the determination unit 321A determines whether to output the recognition command as a command 58 (step S35). The determination process in step S35 includes the same processes as those in steps S9, S11, and S19 in FIG. 11, and therefore, explanation thereof is not repeated herein.

If the determination unit 321A determines to transmit the recognition command (YES in step S43), the recognition command is output as the command 58 to the peripheral function module 101A by the command generation unit 321A (step S45). The command execution unit 120 executes the command 58 received in step S45 (step S46). As a result, the respective components of the MFP 100A are controlled on the basis of the command 58. The peripheral function module 101A outputs a notification that the execution of the command 58 has been completed, to the MFP control module 320A (step S47).

If the determination unit 321 determines that transmission of the recognition command is prohibited (NO in step S43), on the other hand, the recognition command is not output as the command 58 to the peripheral function module 101A, and the notification unit 325A transmits a notification that execution of the command is prohibited, to the voice processing device 200 (step S57). The notification to be transmitted in step S47 or step S57 includes voice data similar to that in the case described above with reference to FIG. 11.

In other embodiments, the voice processing device 200 may be included in the MFP 100A. Further, various modifications including the above described priority determination can also be applied to the system 1A shown in FIGS. 15 and 16.

In this embodiment, when the determination unit 321 (or the determination unit 321A) determines that a recognition command can be transmitted on the basis of an MFP state 341 or the contents of the recognition command in the form of an utterance of the user, a command 58 that is the recognition command is transmitted to the MFP 100 (or the peripheral function module 101A). Therefore, the method for determining whether to permit the determination unit 321 (or the determination unit 321A) of the embodiment to transmit a recognition command of voice data 40 differs from a method by which inputting of voice data to an MFP is uniformly prohibited when the MFP is in operation as disclosed in JP 2005-219460 A.

Because of this, even if the user has inadvertently instructed the MFP 100 (100A) to start executing a job, for example, the MFP 100 (100A) can be operated to suspend or stop the execution of the job in accordance with a command (for canceling, stopping, or interrupting the job, for example) based on an utterance, as long as the MFP state 341 is in a predetermined state (a state in which the operating noise is low, and the voice data 40 can be accurately recognized). Even if the MFP state 341 is not in the predetermined state, it is possible to operate the MFP 100 (100A) to suspend or stop the execution of the job by transmitting a predetermined command based on an utterance to the MFP 100 (100A), as long as the command based on an utterance is a predetermined command (a command with a high degree of urgency). Thus, this embodiment can provide the MFP 100 that has operability improved in accordance with a result of voice recognition.

H. Program>

In each embodiment, a program for causing the MFP 100 (100A) and the server 300 to perform the above described processes is provided. Such a program includes a program for a process according to the sequence in FIG. 11 or the flowchart in FIG. 17. This program can be provided as a program product that is recorded in the computer readable recording medium 176 or 37 accompanying a computer of the MFP 100 (100A) and the server 300, such as a flexible disk, a CD-ROM (Compact Disk-Read Only Memory), a ROM, a RAM, or a memory card. Alternatively, the program may be recorded in a recording medium such as an internal hard disk in a computer. The program may also be provided through downloading via the network 400. The program can be executed by one or more processors such as a CPU, or a combination of a processor and a circuit such as an ASIC or an FPGA.

The program may be designed to invoke necessary modules in a predetermined sequence at a predetermined time among program modules provided as part of the operating system (OS) of a computer, and cause a processor to perform processes. In that case, the modules are not included in the program, but the program cooperates with the OS to perform processes. Such a program that does not include modules may also be included in programs according to the respective embodiments.

A program according to each embodiment may be incorporated into another program, and be provided as part of the other program. In that case, the program does not include the modules included in the other program, and cooperates with the other program to cause a processor to perform processes. Such a program that is incorporated into another program may also be included in programs according to the respective embodiments.

Although embodiments of the present invention have been described and illustrated in detail, the disclosed embodiments are made for purposes of illustration and example only and not limitation. The scope of the present invention should be interpreted not by terms of the above description but by terms of the appended claims, and it should be understood that equivalents of the claimed inventions and all modifications thereof are incorporated herein.

What is claimed is:

1. A system comprising:
an image forming apparatus;
a voice processing device that collects voice of an utterance, and generates voice data of the collected voice; and
a server, wherein
the server includes:
a hardware processor that controls the server; and
a communication circuit that communicates with the image forming apparatus and the voice processing device,
the hardware processor performs a recognition process on the voice data received from the voice processing device, to generate a command for operating the image forming apparatus, and
in a case where the image forming apparatus has received the voice data from the voice processing device while executing a job, when the image forming apparatus is ilia predetermined state of executing the job, or when the command generated from the voice data is a predetermined command, the hardware processor controls the communication circuit to transmit the generated command to the image forming apparatus.

2. The system according to claim 1, wherein the predetermined state includes a state in which operating noise of tile image forming apparatus executing a job is low.

3. The system according to claim 1, wherein
the image forming apparatus receives a command directed to the image forming apparatus,
each status during execution of the job is associated with a priority indicating that a command received by the image forming apparatus during the execution of the job is to be preferentially processed over other commands, and
the priority of the predetermined state is higher than the priority of any other state.

4. The system according to claim 1, wherein,
in a case where the image forming apparatus is not in the predetermined state of executing a job, when the command generated from the voice data is a predetermined command, the hardware processor controls the communication circuit to transmit the generated command to the image forming apparatus.

5. The system according to claim 1, wherein the predetermined command includes a command to be processed preferentially over other commands for operating the image forming apparatus.

6. The system according to claim 5, wherein the predetermined command includes a command for urgently operating the image forming apparatus.

7. The system according to claim 1, wherein
the voice processing device outputs a voice based on a notification from the server, and
in a case where the image forming apparatus receives the voice data from the voice processing device while executing a job, when the image forming apparatus is not in a predetermined state, the hardware processor controls the communication circuit to transmit a notification that the command generated from the voice data is not to be executed by the image forming apparatus to the voice processing device, without transmitting the command to the image forming apparatus.

8. The system according to claim 7, wherein the notification includes information about a time to be taken for executing the job.

9. The system according to claim 1, wherein the server receives a state from the image forming apparatus periodically or when there is a change in the state of the image forming apparatus.

10. The system according to claim 1, wherein
the voice processing device outputs a predetermined notification by voice or lighting in synchronization with a reception cycle of the predetermined notification from the server,
the job includes a job for changing a state of the image forming apparatus to a state in which operating noise is periodically output, and
the hardware processor
measures intervals at which the operating noise is output on a basis of a state received from the image forming apparatus, and
controls the communication circuit to transmit the predetermined notification to the voice processing device at the measured intervals.

11. The system according to claim 1, wherein
the voice processing device outputs an inquiry received from the server by voice or lighting,
the hardware processor further includes
a command storage that stores a plurality of commands for operating the image forming apparatus, and
the hardware processor checks the command generated through the recognition process against each command in the plurality of commands in the command storage, and controls the communication circuit to transmit the inquiry regarding the command based on a result of the check, to the voice processing device.

12. The system according to claim 1, wherein
the image forming apparatus has a silent mode for reducing operating noise of the image forming apparatus, and
the hardware processor controls the communication circuit to transmit an operation command to the image forming apparatus when receiving the voice data from the voice processing device, the operation command being for switching an operation mode of the image forming apparatus to the silent mode.

13. An image forming apparatus comprising:
an image forming unit;
an information processor; and
a communication circuit that collects voice of an utterance, and communicates with a voice processing device that generates voice data of the collected voice, wherein
the information processor performs a recognition process on the voice data received from the voice processing device, to generate a command for operating the image forming unit, and,
in a case where the image forming unit has received the voice data from the voice processing device while executing a job, when the image thrilling unit is in a predetermined state of executing the job, or when the command generated from the voice data is a predetermined command, the information processor outputs the generated command to the image forming unit.

14. A method implemented by a processor included in an information processing device connectable to an image forming unit, the method comprising:
performing a recognition process on voice data based on voice of an utterance, to generate a command for operating the image forming unit; and
outputting the generated command to the image forming unit, when the image forming unit is in a predetermined state of executing a job, or when the command generated from the voice data is a predetermined command, in a case where the image forming unit has received the voice data while executing the job.

15. A non-transitory recording medium storing a computer readable program for causing a computer to implement the method according to claim 14.
